(19) United States
(12) Patent Application Publication
(10) Pub. No.: US 2025/0387931 A1
(43) Pub. Date: Dec. 25, 2025

(54) Cutting Tool Device

(71) Applicant: Joyce Saxton, Visilia, CA (US)

(72) Inventor: Joyce Saxton, Visilia, CA (US)

(21) Appl. No.: 18/951,829

(22) Filed: Nov. 19, 2024

Related U.S. Application Data
(60) Provisional application No. 63/663,712, filed on Jun. 25, 2024.

(51) Int. Cl. B26B 1/02; B26B 9/02

(52) U.S. Cl. CPC B26B 1/02; B26B 9/02

(57) ABSTRACT

A cutting tool device is disclosed, which is used to lift peelable tabs on the packaging of tablet or capsule blister packs. The cutting tool device comprises a blade component that is configured in a teardrop-shaped mechanism with a hook-shaped blade. The blade is configured to cut through foil but not be dangerous and risk cuts and lacerations. Users can easily hold the tool between their thumb and index finger and utilize it to cut open the foil and remove their medication without straining their hands and fingers. The device is placed at the edge of the tab and slices through the foil packaging so it can easily be grasped and removed to reveal the medication.

### CROSS-REFERENCE TO RELATED APPLICATION

The present application claims priority to, and the benefit of, U.S. Provisional Application No. 63/663,712, which was filed on Jun. 25, 2024, and is incorporated herein by reference in its entirety.

### FIELD OF THE INVENTION

The present invention relates generally to the field of cutting tool devices. More specifically, the present invention relates to a small cutting tool for efficiently opening peelable tabs on medication blister packs. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in cutting tool devices. Generally, over the counter medications are commonly stored in airtight packaging with a tab that is lifted and pulled off the back to release the medication. However, it can be difficult to actually remove the tab, especially for people with limited physical dexterity or ailments like arthritis. Further, people may opt to use scissors, letter openers, flat head screwdrivers, or other shape objects to try and cut out the medication, however, this can be inefficient and be risky due to cuts and lacerations.

Unfortunately, some blister packs do not simply have only a soft foil sealing layer but instead a thicker layer sealing the contents within. For instance, there can be a soft foil metal layer against the clear plastic blister layer and then another layer of paper and/or plastic backing over the foil. The blister layer usually consists of a clear PVC/PVDC film. These layers are laminated together in various ways. This type of backing (instead of just a foil layer) is appreciably tougher which makes it harder or even impossible for the user to perform the usual methods of poking through the backing to access the contents or pressing on the blister to push the contents out through the backing. To manually remove a pill with traditional methods, one is required to first separate an individual blister unit (tear it off from the flat along perforations). Then one must remove the outer foil layer and then the inner layer to access the pill. This can be frustrating for a user, trying to access the medication.

Accordingly, there is a demand for an improved cutting tool device that allows users to efficiently open peelable tabs on medication blister packs. More particularly, there is a demand for a cutting tool device that allows users with limited hand strength to easily open their medication packs without struggle.

Therefore, there exists a long felt need in the art for a cutting tool device that provides users with a small cutting tool for efficiently opening peelable tabs on medication blister packs. There is also a long felt need in the art for a cutting tool device that features a teardrop-like shape with a cutting tool on one end that easily slices through the foil on the medication pack. Further, there is a long felt need in the art for a cutting tool device that allows users with limited hand strength to easily open their medication packs without struggle. Moreover, there is a long felt need in the art for a device that can be included with medication or purchased as an individual reusable tool. Further, there is a long felt need in the art for a cutting tool device that eliminates the need to try and struggle to peel open difficult foil packs by hand. Finally, there is a long felt need in the art for a cutting tool device that can cut through foil but is not dangerous to risk cuts and lacerations.

The subject matter disclosed and claimed herein, in one embodiment thereof, comprises a cutting tool device. The device is a tool used to lift peelable tabs on the packaging of tablet or capsule blister packs. The cutting tool device comprises a blade component that is configured in a teardrop-shaped mechanism with a hook-shaped blade. The blade is configured to cut through foil but not be dangerous and risk cuts and lacerations. Users can easily hold the tool between their thumb and index finger and utilize it to cut open the foil and remove their medication without straining their hands and fingers. The device is placed at the edge of the tab and slices through the foil packaging so it can easily be grasped and removed to reveal the medication.

In this manner, the cutting tool device of the present invention accomplishes all of the forgoing objectives and provides users with a device that easily opens medication packs. The device is a small cutting tool. The device can be included with medication or purchased separately.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cutting tool device. The cutting tool device comprises a blade component with a hook-shaped blade. Generally, the cutting tool device is a tool used to lift peelable tabs on the packaging of tablet or capsule blister packs. The device allows users with limited hand strength to easily open their medication packs without struggle. Thus, the cutting tool device eliminates the need to try and struggle to peel open difficult foil packs by hand.

In one embodiment, the cutting tool device is typically used with foil sealed, blister packs for medication, or any other suitable medication pack as is known in the art. Specifically, blister packs include soft packs, plastic-packs, paper-packs, metal/foil packs or packs using a combination of materials which enclose powder, pills, capsules or even liquid capsules or other medication or medicine related dosages or dosages of non-medicine related material in the form of individual blister units which are segregated from one another. Typically, the blister packs have a plurality of individual blister units, which usually rise in parallel rows of five blister units. The blister units tend to be more or less identical dimensionally, from one brand or type of blister pack to another, but there can be some variations such as the size of the blister pocket, angles of blister walls, and foil/plastic/paper backing and blister plastic thickness, etc. There are also spaces between the blister units. The blister units can contain any suitable medication as is known in the art. Further, the blister packs can have multiple layer seals, or a seal with a single layer. Further, the blister packs are designed so that the user will push the unit dosage out or at least open a unit dosage containment by pushing and therefore bursting or puncturing the blister pack backing. Thus, the present invention is directed to a cutting tool device for opening units of medication contained in a blister pack of individually segregated unit dosages of material such as medication.

In one embodiment, the cutting tool device comprises a blade component that is configured in a teardrop-shaped configuration. The blade component can be any suitable shape and size as is known in the art, with a front surface and a rear surface. Typically, the teardrop-shaped configuration allows a user to hold the blade component with ease between their fingers. Further, the blade component can have an ergonomical indentation on its front and rear surfaces, as well as a surface textured area for extra gripping by the user. The exterior of the front and rear surfaces of the blade component can provide places to grip the device while using it. Specifically, users can easily hold the blade component between their thumb and index finger and utilize it to cut open the foil package and remove their medication without straining their hands and fingers. Further, the materials, dimensions and shape of the blade component of the device can be varied to make is easier to grip or more portable or compact or attractive or economical without departing from the spirit and scope of the present invention.

In one embodiment, the blade component comprises a hook-shaped blade. The blade is configured in a hook-shape so as to allow a user to not only cut the foil package but also to lift up the foil and pull the foil away from the medication, revealing the pill/medication. Further, the blade is configured to cut through foil but not be so sharp that it is dangerous, so as not to risk cuts and lacerations during use. The hook-shaped blade can be any suitable blade as is known in the art, as long as the hook-shaped blade is sharp enough to cut through a foil package. In one embodiment, the hook-shaped blade has a serrated edge. In one embodiment, the hook-shaped blade is a straight, non-serrated blade. In yet another embodiment, the hook-shaped blade is a recessed blade which can be slid in and out or pivoted in and out, as needed.

In one embodiment, the hook-shaped blade is contained in a recess of the blade component, which retains part of the blade and allows a portion of the blade to protrude beyond the blade component. The blade is secure because the recess is shaped to receive it, plus the cutting motion tends to press the blade back into its recess, all of which combines to prevent the blade from popping out. Further, in another embodiment, the blade is retained via a hinge or pin to the blade component, to allow movement in and out, as needed.

In one embodiment, the recess which receives the hook-shaped blade can also have protrusions which go through holes/notches of the blade to further secure the blade within the blade component.

In one embodiment, the hook-shaped blade comprises a blade guard, which prevents accidental contact with the blade.

In one embodiment, the hook-shaped blade's cutting edge can be angled relative to the plane defined by the sealing foil to form an attack angle. The attack angle affects how the cutting edge of the blade cuts and that the sharp edge of the blade is not exposed, so as to be a danger to the user when in held in their hand. For example, the closer this attack angle is to perpendicular or ninety degrees relative to the sealing foil, the more the blade is ramming through the foil backing. The closer to zero degrees, the more slicing (as opposed to ramming) results. A higher attack angle requires a shorter exposed cutting edge and a lower attack angle requires a longer cutting edge. As slicing requires less effort than ramming and tends to create a smoother cut edge of the foil backing, the smaller the attack angle the easier and smoother the cutting motion will be in general.

In one embodiment, a thinner blade deflects more than a thicker blade, but a thicker blade has more drag. And, of course, blades can have various coatings to reduce drag but may cost more than uncoated blades or the user may not want said coating to contact the foil backing. These conflicting advantages and disadvantages can be balanced by the individual user's needs and/or wants.

In one embodiment, the hook-shaped blade is manufactured of stainless steel, titanium, hard plastic, or any other suitable metal material, non-metal materials, or combination of materials.

In one embodiment, the cutting tool device is included with a user's medication packages, and then disposed of after use. In another embodiment, the cutting tool device is purchased individually, as a reusable tool. Overall, the cutting tool device is an economical, pocket-sized tool which comfortably fits in the palm of one's hand. Further, there are many sizes, shapes, thicknesses and types of cutting blades that could be used, without departing from the spirit and scope of the present invention.

In operation, the cutting tool device is held in a user's hand with the user positioning the blade component between a user's thumb and index finger. Once in a user's hand, the hook-shaped blade is then placed at the edge of the foil package tab. Once in position, the hook-shaped blade is pressed into the foil package and slices through the foil packaging. Once the foil packaging is split open, a user can then utilize the hook-shaped blade to lift up and peel back the foil, revealing the medication. Once revealed, the user can then easily grasp the medication/pill for use.

In yet another embodiment, the cutting tool device comprises a plurality of indicia.

In yet another embodiment, a method of opening a medication pack with ease is disclosed. The method includes the steps of providing a cutting tool device comprising a blade component with a blade. The method also comprises positioning the blade component at an edge of a blister pack. Further, the method comprises slicing through the foil packaging of the blister pack. The method also comprises using the blade component to lift up the foil packaging. Finally, the method comprises removing the pill from the blister package with ease.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the cutting tool device of the present invention showing the device slicing through foil packaging in accordance with the disclosed architecture;

FIG. 2 illustrates a perspective view of one embodiment of the cutting tool device of the present invention showing the device opening the foil package in accordance with the disclosed architecture;

FIG. 3 illustrates a perspective view of one embodiment of the cutting tool device of the present invention showing the device peeling up the foil from the package in accordance with the disclosed architecture;

FIG. 4 illustrates a perspective view of one embodiment of the cutting tool device of the present invention showing the device positioned on the lifting tab of the package in accordance with the disclosed architecture;

FIG. 5 illustrates a perspective view of one embodiment of the cutting tool device of the present invention showing the device next to a medication package in accordance with the disclosed architecture; and

FIG. 6 illustrates a flowchart showing the method of opening a medication pack with case in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a cutting tool device that provides users with a small cutting tool for efficiently opening peelable tabs on medication blister packs. There is also a long felt need in the art for a cutting tool device that features a teardrop-like shape with a cutting tool on one end that easily slices through the foil on the medication pack. Further, there is a long felt need in the art for a cutting tool device that allows users with limited hand strength to easily open their medication packs without struggle. Moreover, there is a long felt need in the art for a device that can be included with medication or purchased as an individual reusable tool. Further, there is a long felt need in the art for a cutting tool device that eliminates the need to try and struggle to peel open difficult foil packs by hand. Finally, there is a long felt need in the art for a cutting tool device that can cut through foil but is not dangerous to risk cuts and lacerations.

The present invention, in one exemplary embodiment, is a novel cutting tool device. The cutting tool device comprises a blade component that is configured in a teardrop-shaped mechanism with a hook-shaped blade. The blade is configured to cut through foil but not be dangerous and risk cuts and lacerations. Users can easily hold the tool between their thumb and index finger and utilize it to cut open the foil and remove their medication without straining their hands and fingers. The device is placed at the edge of the tab and slices through the foil packaging so it can easily be grasped and removed to reveal the medication. The present invention also includes a novel method of opening a medication pack with ease. The method includes the steps of providing a cutting tool device comprising a blade component with a blade. The method also comprises positioning the blade component at an edge of a blister pack. Further, the method comprises slicing through the foil packaging of the blister pack. The method also comprises using the blade component to lift up the foil packaging. Finally, the method comprises removing the pill from the blister package with case.

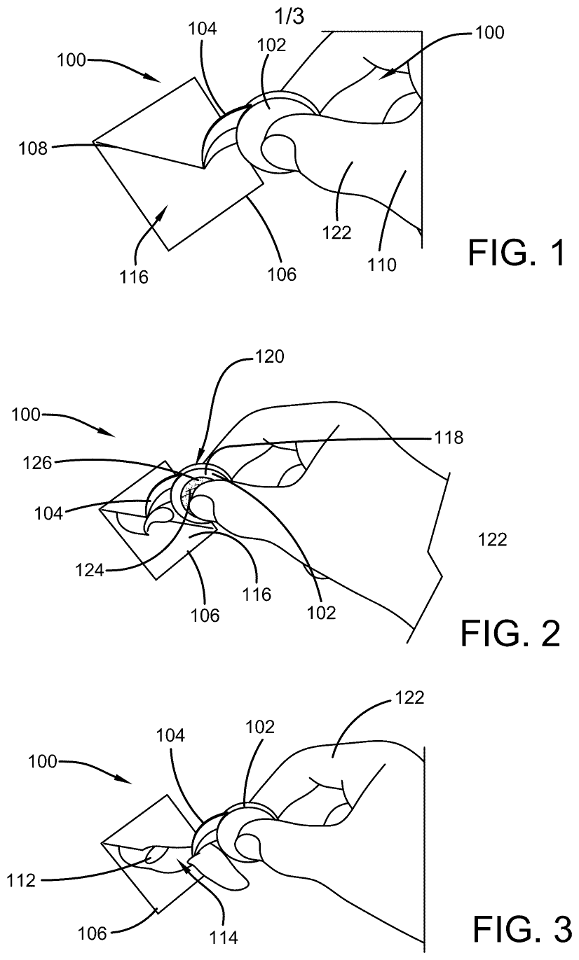

Referring initially to the drawings, FIG. 1 illustrates a perspective view of one embodiment of the cutting tool device 100 of the present invention. In the present embodiment, the cutting tool device 100 is an improved cutting tool device 100 that provides a user 110 with a means for easily opening foil pill packs or blister packs 106, etc. Specifically, the cutting tool device 100 comprises a blade component 102 with a hook-shaped blade 104.

Generally, the cutting tool device 100 is a tool used to lift peelable tabs 108 on the packaging of tablet or capsule blister packs 106. The device 100 allows users 110 with limited hand strength to easily open their medication packs 106 without struggle. Thus, the cutting tool device 100 eliminates the need to try and struggle to peel open difficult foil packs 106 by hand.

Further, the cutting tool device 100 is typically used with foil sealed, blister packs 106 for medication 112, or any other suitable medication pack as is known in the art. Specifically, blister packs 106 include soft packs, plastic-packs, paper-packs, metal/foil packs or packs using a combination of materials which enclose powder, pills, capsules or even liquid capsules or other medication 112 or medicine related dosages or dosages of non-medicine related material in the form of individual blister units 114 which are segregated from one another. Typically, the blister packs 106 have a plurality of individual blister units 114, which usually rise in parallel rows of five blister units 114. The blister units 114 tend to be more or less identical dimensionally, from one brand or type of blister pack 106 to another, but there can be some variations such as the size of the blister pocket, angles of blister walls, and foil/plastic/paper backing 116 and blister plastic thickness, etc. There are also spaces between the blister units 114. The blister units 114 can contain any suitable medication as is known in the art. Further, the blister packs 106 can have multiple layer seals, or a seal with a single layer. Further, the blister packs 106 are designed so that the user 110 will push the unit dosage out or at least open a unit dosage containment by pushing and therefore bursting or puncturing the blister pack backing 116. Thus, the present invention is directed to a cutting tool device 100 for opening units of medication 112 contained in a blister pack 106 of individually segregated unit dosages of material such as medication 112.

Additionally, the cutting tool device 100 comprises a blade component 102 that is configured in a teardrop-shaped configuration. The blade component 102 can be any suitable shape and size as is known in the art, with a front surface 118 and a rear surface 120. Typically, the teardrop-shaped configuration allows a user 110 to hold the blade component 102 with case between their fingers 122. Further, the blade component 102 can have an ergonomical indentation 124 on its front 118 and rear 120 surfaces, as well as a surface textured area 126 for extra gripping by the user 110. The exterior of the front 118 and rear 120 surfaces of the blade component 102 can provide places to grip the device 100 while using it. Specifically, users 110 can easily hold the blade component 102 between their thumb and index finger 122 and utilize it to cut open the foil package/backing 116 and remove their medication 112 without straining their hands and fingers 122. Further, the materials, dimensions and shape of the blade component 102 of the device 100 can be varied to make is easier to grip or more portable or compact or attractive or economical without departing from the spirit and scope of the present invention.

As shown in FIGS. 2-3, the blade component 102 comprises a hook-shaped blade 104. The blade 104 is configured in a hook-shape so as to allow a user 110 to not only cut the foil package/backing 116 but also to lift up the foil 116 and pull the foil 116 away from the medication 112, revealing the pill/medication 112. Further, the blade 104 is configured to cut through foil 116 but not be so sharp that it is dangerous, so as not to risk cuts and lacerations during use. The hook-shaped blade 104 can be any suitable blade as is known in the art, as long as the hook-shaped blade 104 is sharp enough to cut through a foil package 116. In one embodiment, the hook-shaped blade 104 has a serrated edge. In one embodiment, the hook-shaped blade 104 is a straight, non-serrated blade. In yet another embodiment, the hook-shaped blade 104 is a recessed blade which can be slid in and out or pivoted in and out, as needed.

In one embodiment, the hook-shaped blade 104 is contained in a recess 200 of the blade component 102, which retains part of the blade 104 and allows a portion of the blade 104 to protrude beyond the blade component 102. The blade 104 is secure because the recess 200 is shaped to receive it, plus the cutting motion tends to press the blade 104 back into its recess 200, all of which combines to prevent the blade 104 from popping out. In one embodiment, the recess 200 which receives the hook-shaped blade 104 can also have protrusions 204 which go through holes/notches 206 of the blade 104 to further secure the blade 104 within the blade component 102. Further, in another embodiment, the blade 104 is retained via a hinge or pin 202 to the blade component 102, to allow movement in and out, as needed.

In one embodiment, the hook-shaped blade's cutting edge 104 can be angled relative to the plane defined by the sealing foil 116 to form an attack angle. The attack angle affects how the cutting edge of the blade 104 cuts and that the sharp edge of the blade 104 is not exposed, so as to be a danger to the user 110 when in held in their hand. For example, the closer this attack angle is to perpendicular or ninety degrees relative to the sealing foil 116, the more the blade 104 is ramming through the foil backing 116. The closer to zero degrees, the more slicing (as opposed to ramming) results. A higher attack angle requires a shorter exposed cutting edge and a lower attack angle requires a longer cutting edge. As slicing requires less effort than ramming and tends to create a smoother cut edge of the foil backing 116, the smaller the attack angle the easier and smoother the cutting motion will be in general.

Further, a thinner blade deflects more than a thicker blade, but a thicker blade has more drag. And, of course, blades 104 can have various coatings to reduce drag but may cost more than uncoated blades or the user 110 may not want said coating to contact the foil backing 116. These conflicting advantages and disadvantages can be balanced by the individual user's needs and/or wants.

In yet another embodiment, the hook-shaped blade 104 comprises a blade guard 208, which prevents accidental contact with the blade 104. Users 110 merely remove the blade guard 208 for use and replace it for safe storage of the device 100.

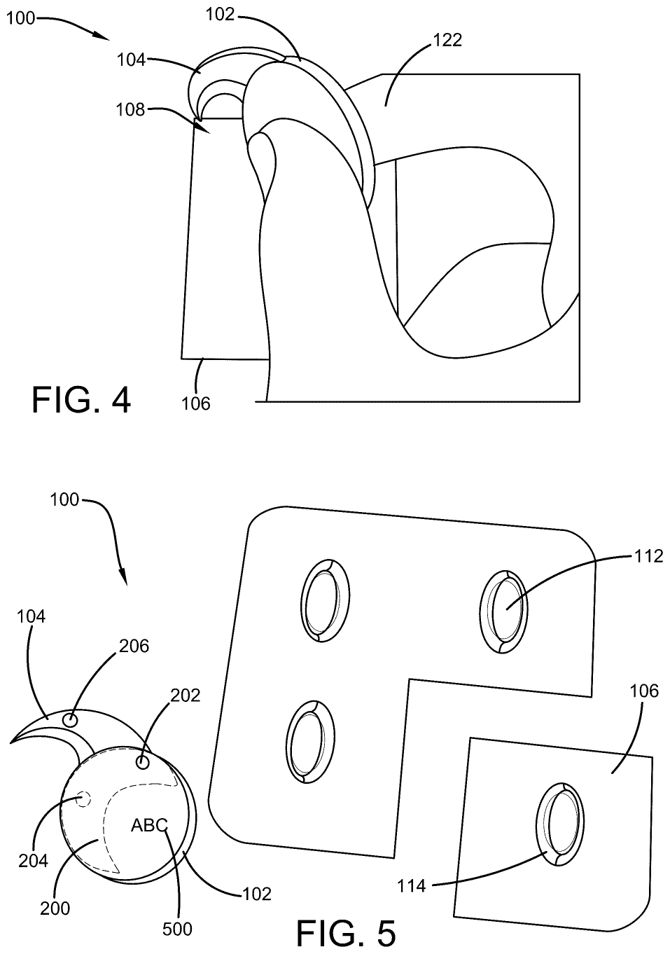

As shown in FIG. 4, in operation, the cutting tool device 100 is held in a user's hand with the user 110 positioning the blade component 102 between a user's thumb and index finger 122. Once in a user's hand, the hook-shaped blade 104 is then placed at the edge of the foil package tab 108. Once in position, the hook-shaped blade 104 is pressed into the foil package 116 and slices through the foil packaging 116. Once the foil packaging 116 is split open, a user 110 can then utilize the hook-shaped blade 104 to lift up and peel back the foil 116, revealing the medication 112. Once revealed, the user 110 can then easily grasp the medication/pill 112 for use.

As shown in FIG. 5, the hook-shaped blade 104 is manufactured of stainless steel or titanium or any other suitable metal materials or combination of materials as is known in the art.

In one embodiment, the cutting tool device 100 is included with a user's medication packages 106, and then disposed of after use. In another embodiment, the cutting tool device 100 is purchased individually, as a reusable tool. Overall, the cutting tool device 100 is an economical, pocket-sized tool which comfortably fits in the palm of one's hand. Further, there are many sizes, shapes, thicknesses and types of cutting blades 104 that could be used, without departing from the spirit and scope of the present invention.

In yet another embodiment, the cutting tool device 100 comprises a plurality of indicia 500. The blade component 102 of the device 100 may include advertising, a trademark, or other letters, designs, or characters, printed, painted, stamped, or integrated into the blade component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be blister pack, medication, or brand related.

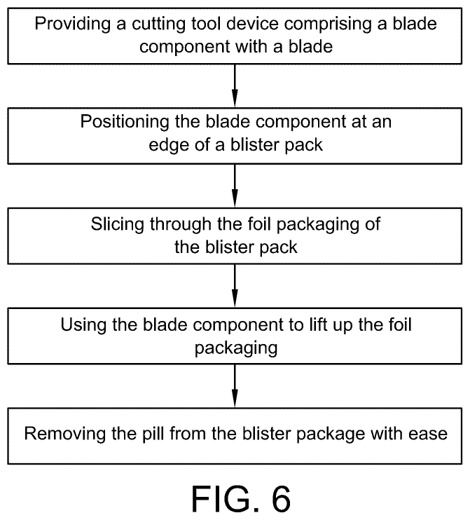

FIG. 6 illustrates a flowchart of the method of opening a medication pack with ease. The method includes the steps of at 600, providing a cutting tool device comprising a blade component with a blade. The method also comprises at 602, positioning the blade component at an edge of a blister pack. Further, the method comprises at 604, slicing through the foil packaging of the blister pack. The method also comprises at 606, using the blade component to lift up the foil packaging. Finally, the method comprises at 608, removing the pill from the blister package with case.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “cutting tool device”, “cutting device”, “tool device”, and “device” are interchangeable and refer to the cutting tool device 100 of the present invention.

Notwithstanding the forgoing, the cutting tool device 100 of the present invention can be of any suitable size and configuration as is known in the art without affecting the overall concept of the invention, provided that it accomplishes the above stated objectives. One of ordinary skill in the art will appreciate that the cutting tool device 100 as shown in FIGS. 1-6 is for illustrative purposes only, and that many other sizes and shapes of the cutting tool device 100 are well within the scope of the present disclosure. Although the dimensions of the cutting tool device 100 are important design parameters for user convenience, the cutting tool device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cutting tool device that provides a user with a means for easily opening foil pill packs, the cutting tool device comprising:
a blade component; and
a blade;
wherein the blade is secured to the blade component for use;
wherein the blade easily slices through foil backing of a blister pack of medication; and
further wherein the cutting tool device opens units of medication contained in a blister pack with ease.

2. The cutting tool device of claim 1, wherein the cutting tool device is typically used with foil sealed, blister packs of medication, with at least one seal layer.

3. The cutting tool device of claim 2, wherein the blade component is configured in a teardrop-shaped configuration to allow a user to hold it between their fingers with ease.

4. The cutting tool device of claim 3, wherein the blade component has a front surface and a rear surface.

5. The cutting tool device of claim 4, wherein the blade component has an ergonomical indentation on the front and rear surfaces.

6. The cutting tool device of claim 5, wherein the blade component has a surface textured area for extra gripping on the front and rear surfaces.

7. The cutting tool device of claim 6, wherein the blade is configured in a hook-shape to allow a user to cut the foil backing but also to lift up foil and pull it away to reveal the medication.

8. The cutting tool device of claim 7, wherein the blade has a serrated edge.

9. The cutting tool device of claim 7, wherein the blade has a straight, non-serrated blade.

10. The cutting tool device of claim 7, wherein the blade is contained in a recess of the blade component, which retains a part of the blade and allows a portion of the blade to protrude beyond the blade component.

11. The cutting tool device of claim 10, wherein the recess has protrusions which mate with notches of the blade to further secure the blade within the blade component.

12. The cutting tool device of claim 11, wherein the blade comprises a blade guard.

13. A cutting tool device that provides a user with a means for easily opening foil pill packs, the cutting tool device comprising:
a blade component configured in a teardrop-shaped configuration to allow a user to hold it between their fingers with ease; and
a blade configured in a hook-shape to allow a user to cut a foil backing but also to lift up foil and pull it away to reveal medication;
wherein the blade component has an ergonomical indentation on a front and rear surfaces;
wherein the blade is contained in a recess of the blade component, which retains a part of the blade and allows a portion of the blade to protrude beyond the blade component;
wherein the recess has protrusions which mate with notches of the blade to further secure the blade within the blade component;
wherein the blade comprises a blade guard;
wherein the blade easily slices through foil backing of a blister pack of medication; and
further wherein the cutting tool device opens units of medication contained in a blister pack with ease.

14. The cutting tool device of claim 13, wherein the blade is a recessed blade which can pivoted in and out, as needed.

15. The cutting tool device of claim 13, wherein the blade is retained via a hinge to the blade component, to allow movement in and out, as needed.

16. The cutting tool device of claim 13, wherein the blade is manufactured of stainless steel or titanium.

17. The cutting tool device of claim 13, wherein the cutting tool device is included with a user's medication packages, and then disposed of after use.

18. The cutting tool device of claim 13 wherein the cutting tool device is purchased individually, as a reusable tool.

19. The cutting tool device of claim 13 further comprising a plurality of indicia.

20. A method of opening a medication pack with ease, the method comprising the following steps:
providing a cutting tool device comprising a blade component with a blade;
positioning the blade component at an edge of a blister pack;
slicing through the foil packaging of the blister pack;
using the blade component to lift up the foil packaging; and
removing the pill from the blister package with ease.
